(19) United States
(12) Patent Application Publication
(10) Pub. No.: US 2026/0065854 A1
(43) Pub. Date: Mar. 5, 2026

(54) PROCESSOR AND PIXEL DEGRADATION COMPENSATION METHOD THEREOF

(71) Applicant: Novatek Microelectronics Corp., Hsinchu (TW)

(72) Inventors: Li-Chieh Chen, Hsinchu County (TW); Yen-Tao Liao, Hsinchu City (TW)

(73) Assignee: Novatek Microelectronics Corp., Hsinchu (TW)

(21) Appl. No.: 18/817,111

(22) Filed: Aug. 27, 2024

(51) Int. Cl. G09G 3/3225

(52) U.S. Cl. CPC G09G 3/3225; G09G 2320/0285; G09G 2320/046; G09G 2320/048; G09G 2320/0626; G09G 2360/12; G09G 2360/16

(57) ABSTRACT

The disclosure provides a processor and a pixel degradation compensation method thereof. The processor includes a processing circuit and a pixel degradation compensation circuit. The pixel degradation compensation circuit is coupled to the processing circuit to receive image frame data. The pixel degradation compensation circuit adjusts the grayscales of all sub-pixel data of the image frame data based on a grayscale adjustment rate corresponding to the image frame data to generate adjusted image frame data. The pixel degradation compensation circuit generates a total degradation value corresponding to current sub-pixel data in the adjusted image frame data based on the current sub-pixel data. The pixel degradation compensation circuit compensates the current sub-pixel data based on the total degradation value corresponding to the current sub-pixel data to generate compensated current sub-pixel data in compensated image frame data to a display module.

### BACKGROUND

### Technical Field

The disclosure relates to a display device, and particularly relates to a processor and a pixel degradation compensation method thereof.

### Description of Related Art

For organic light-emitting diode (OLED) displays, pixel degradation (also known as burn-in) is one of many technical issues. Different operating temperatures, OLED materials, and drive currents will cause sub-pixels to suffer different degradation effects. A lookup table (LUT) established based on optical measurements for decay factor (DF) accumulation and data compensation may overcome the problem. When the brightness of the sub-pixel is attenuated due to degradation, the brightness attenuation may be improved by appropriately increasing/compensating the digital value (grayscale value) of the sub-pixel data. For degraded sub-pixels, the more serious the brightness attenuation is, the greater the compensation value of the sub-pixel data (the additional compensation current applied to the degraded sub-pixel circuit), so that the degraded sub-pixel circuit may maintain the target brightness. However, the improvement space (compensation region) of the sub-pixel data is limited.

Generally speaking, the degradation speeds of red sub-pixels, green sub-pixels, and blue sub-pixels are different. FIG. 1 is a schematic diagram of a characteristic curve of a degradation speed of different color sub-pixels of an OLED. The horizontal axis shown in FIG. 1 represents the historical usage time (in hours), while the vertical axis represents the normalized luminance. It can be known from the characteristic curve shown in FIG. 1 that the degradation speed of the blue sub-pixels (characteristic curve B) is greater than the degradation speed of the red sub-pixels (characteristic curve R) and the degradation speed of the green sub-pixels (characteristic curve G). Compared with the red sub-pixels and the green sub-pixels, the compensation region (sub-pixel data improvement space) of the blue sub-pixels may be saturated first. If the compensation region of any one color is saturated while the compensation regions of other colors are not, the display module will experience a color shift. That is, the display module continues to degrade, but the compensation regions of part of colors may not be effectively compensated due to saturation.

It should be noted that the content of the “BACKGROUND” section is used to help understand the disclosure. Some of the content (or all of the content) disclosed in the “BACKGROUND” section may not be known by those of ordinary skill in the art. The content disclosed in the “BACKGROUND” section does not mean that the content has been known to those with ordinary knowledge in the technical field before the application of the disclosure.

### SUMMARY

The disclosure provides a processor and a pixel degradation compensation method thereof to compensate for the sub-pixel circuit degradation.

In an embodiment of the disclosure, the processor includes a processing circuit and a pixel degradation compensation circuit. The pixel degradation compensation circuit is coupled to the processing circuit to receive image frame data. The pixel degradation compensation circuit is used to compensate the image frame data to generate compensated image frame data to a display module. The pixel degradation compensation circuit generates a grayscale adjustment rate corresponding to the image frame data. The pixel degradation compensation circuit adjusts grayscales of all sub-pixel data of the image frame data based on the grayscale adjustment rate to generate adjusted image frame data. The pixel degradation compensation circuit generates a total degradation value corresponding to current sub-pixel data in the adjusted image frame data based on the current sub-pixel data. The total degradation value represents a historical degradation effect of the current sub-pixel data on a sub-pixel corresponding to the current sub-pixel data in the display module. The pixel degradation compensation circuit compensates the current sub-pixel data in the adjusted image frame data based on the total degradation value corresponding to the current sub-pixel data to generate compensated current sub-pixel data in the compensated image frame data to the display module.

In an embodiment of the disclosure, the pixel degradation compensation method includes the following steps. A grayscale adjustment rate corresponding to image frame data is generated. The grayscales of all sub-pixel data of the image frame data are adjusted based on the grayscale adjustment rate to generate adjusted image frame data. A total degradation value corresponding to current sub-pixel data in the adjusted image frame data is generated based on the current sub-pixel data. The total degradation value represents a historical degradation effect of the current sub-pixel data on a sub-pixel corresponding to the current sub-pixel data in a display module. The current sub-pixel data in the adjusted image frame data is compensated based on the total degradation value corresponding to the current sub-pixel data to generate compensated current sub-pixel data in compensated image frame data to the display module.

Based on the above, the pixel degradation compensation circuit described in the embodiments of the disclosure may compensate the image frame data output by the processing circuit to generate the compensated image frame data to the display module. In an embodiment, the pixel degradation compensation circuit may appropriately reduce the grayscales of all sub-pixel data of the image frame data, and then compensate the adjusted grayscale of the image frame data to compensate for the sub-pixel degradation of the display module, thereby overcoming the technical issue of color shift. By reducing the grayscales of all sub-pixel data of the image frame data, the pixel degradation compensation circuit may slow down the accumulation speed of the degradation value before the compensation region is saturated, thereby prolonging the saturation time of the compensation region to avoid the occurrence of color shift. In addition, by reducing the grayscales of all sub-pixel data of the image frame data, the pixel degradation compensation circuit may reduce the additional compensation current for the sub-pixel circuit, thereby extending the lifetime of the sub-pixel circuit.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic diagram of a characteristic curve of a degradation speed of different color sub-pixels of an organic light-emitting diode (OLED).

FIG. 2 is a schematic circuit block diagram of a display device according to an embodiment of the disclosure.

FIG. 3 is a schematic flowchart of a pixel degradation compensation method according to an embodiment of the disclosure.

FIG. 4 is a schematic circuit block diagram of a processing circuit according to an embodiment of the disclosure.

FIG. 5 is a schematic diagram of remapping original image frame data to image frame data according to an embodiment of the disclosure.

FIG. 6 is a schematic circuit block diagram of a pixel degradation compensation circuit according to an embodiment of the disclosure.

FIG. 7 is a schematic circuit block diagram of a frame grayscale adjustment circuit according to an embodiment of the disclosure.

FIG. 8 is a schematic circuit block diagram of a frame grayscale adjustment circuit according to another embodiment of the disclosure.

FIG. 9 is a schematic circuit block diagram of a degradation compensator according to an embodiment of the disclosure.

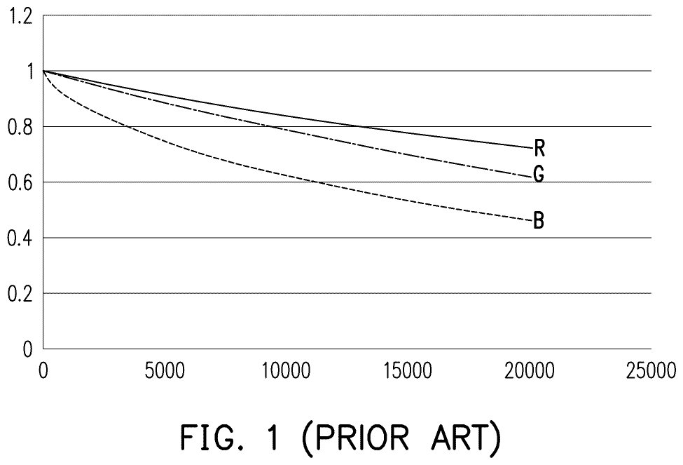

### DESCRIPTION OF THE EMBODIMENTS

The word “coupled to (or connected to)” as used throughout this specification (including the scope of the application) may refer to any direct or indirect means of connection. For example, if it is described in the specification that a first device is coupled (or connected) to a second device, it should be construed that the first device may be directly connected to the second device, or the first device may be indirectly connected to the second device through another device or some type of connecting means. The terms “first” and “second” and the like mentioned in the full text (including the scope of the patent application) of the description of this application are used only to name the elements or to distinguish different embodiments or scopes and are not intended to limit the upper or lower limits of the number of the elements, nor is it intended to limit the order of elements. Also, where possible, elements/components/steps using the same reference numerals in drawings and embodiments represent the same or similar parts. Elements/components/steps that use the same reference numerals or use the same terminology in different embodiments may refer to relative descriptions of each other.

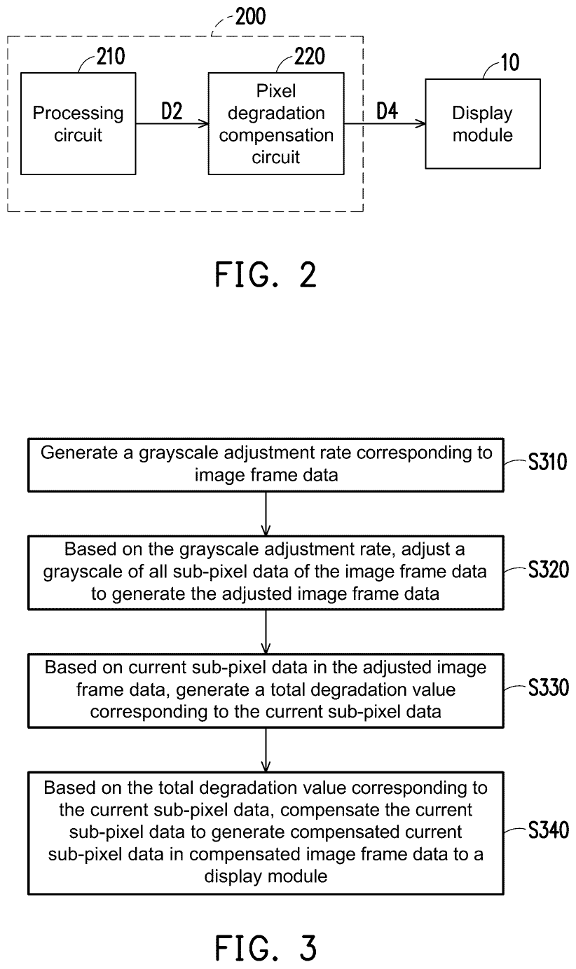

FIG. 2 is a schematic circuit block diagram of a display device according to an embodiment of the disclosure. The display device shown in FIG. 2 includes a display module 10 and a processor 200. Based on reality, the display module 10 may include an organic light-emitting diode (OLED) display panel or other display panels. Based on the decay factor (DF) such as usage time, temperature, material, and drive current, different sub-pixel circuits of the display module 10 will suffer different degradation effects. In the case where the brightness of the sub-pixel circuit is attenuated due to degradation, the actual brightness of the degraded sub-pixel may be lower than the target brightness.

In the embodiment shown in FIG. 2, the processor 200 includes a processing circuit 210 and a pixel degradation compensation circuit 220. According to different designs, in some embodiments, the implementation of the processor 200, the processing circuit 210, and/or the pixel degradation compensation circuit 220 may be hardware circuit. In other embodiments, the implementation of the processor 200, the processing circuit 210, and/or the pixel degradation compensation circuit 220 may be firmware, software (i.e., programs), or a combination of the above-mentioned two implementations. In yet other embodiments, the implementation of the processor 200, the processing circuit 210, and/or the pixel degradation compensation circuit 220 may be a combination of more than one of hardware, firmware, and software.

In terms of hardware, the processor 200, the processing circuit 210, and/or the pixel degradation compensation circuit 220 may be implemented as logic circuits on an integrated circuit. For example, the related functions of the processor 200, the processing circuit 210, and/or the pixel degradation compensation circuit 220 may be implemented in one or more controllers, microcontrollers, microprocessors, application-specific integrated circuits (ASIC), digital signal processor (DSP), field programmable gate array (FPGA), central processing unit (CPU), and/or various logical blocks, modules, and circuits in other processing units. The related functions of the processor 200, the processing circuit 210, and/or the pixel degradation compensation circuit 220 may be implemented as hardware circuits using hardware description languages (such as Verilog HDL or VHDL) or other suitable programming languages, such as various logic blocks, modules, and circuits in an integrated circuit.

In terms of software and/or firmware, the related functions of the processor 200, the processing circuit 210, and/or the pixel degradation compensation circuit 220 may be implemented as programming codes. For example, the processor 200, the processing circuit 210, and/or the pixel degradation compensation circuit 220 may be implemented using general programming languages (such as C, C++, or assembly language) or other suitable programming languages. The programming code may be recorded/stored in a “non-transitory machine-readable storage medium” or a computer program product. In some embodiments, the non-transitory machine-readable storage medium includes, for example, a semiconductor memory and/or a storage device. An electronic device (such as a computer, a CPU, a controller, a processor, a microcontroller, or a microprocessor) may read and execute the programming code from the non-transitory machine-readable storage medium, thereby achieving the related functions of the processor 200, the processing circuit 210, and/or the pixel degradation compensation circuit 220. Alternatively, the programming code or computer program product may be provided to the electronic device via any transmission medium (such as a communication network or broadcast waves, etc.). The communication network is, for example, the Internet, a wired communication network, a wireless communication network, or other communication media.

The driving value range of the display module 10 is divided into an image region and a compensation region. Each sub-pixel data of image frame data D2 belongs to the image region. The processing circuit 210 remaps an original image frame data to the image frame data D2. The pixel degradation compensation circuit 220 is coupled to the processing circuit 210 to receive the image frame data D2. The pixel degradation compensation circuit 220 may compensate the image frame data D2 to generate compensated image frame data D4 to the display module 10. The pixel degradation compensation circuit 220 may apply a pixel degradation compensation method to compensate for the sub-pixel degradation of the display module 10 so as to overcome the technical issue of color shift. A specific example of the pixel degradation compensation method will be described below.

FIG. 3 is a schematic flowchart of a pixel degradation compensation method according to an embodiment of the disclosure. Refer to FIG. 2 and FIG. 3. In step S310, the pixel degradation compensation circuit 220 may generate a grayscale adjustment rate corresponding to the image frame data D2. Based on the grayscale adjustment rate, the pixel degradation compensation circuit 220 may adjust the grayscales of all sub-pixel data of the image frame data D2 to generate the adjusted image frame data (step S320). In some application examples, the pixel degradation compensation circuit 220 may use the existing DBV (display brightness value) adjustment mechanism of general display devices to reduce the grayscale (brightness) of the image frame data D2. In other application examples, the pixel degradation compensation circuit 220 may set up a dedicated frame grayscale adjustment circuit to reduce the grayscale (brightness) of the image frame data D2.

Based on a certain sub-pixel data (the current sub-pixel data) in the adjusted image frame data, the pixel degradation compensation circuit 220 may generate a total degradation value corresponding to the current sub-pixel data (step S330). The total degradation value represents a historical degradation effect of the current sub-pixel data on a certain sub-pixel corresponding to the current sub-pixel data in the display module 10. The embodiment does not limit the algorithm of the total degradation value. For example, the pixel degradation compensation circuit 220 may use a conventional algorithm or other algorithms in step S330 to calculate the total degradation value corresponding to the current sub-pixel data based on at least one of many decay factors such as sub-pixel data (drive current), usage time, temperature, etc. In step S340, the pixel degradation compensation circuit 220 compensates the current sub-pixel data in the adjusted image frame data based on the total degradation value corresponding to the current sub-pixel data to generate compensated current sub-pixel data in the compensated image frame data D4 to the display module 10.

In summary, the pixel degradation compensation circuit 220 may compensate the image frame data D2 output by the processing circuit 210 to generate the compensated image frame data D4 to the display module 10. In an embodiment, the pixel degradation compensation circuit 220 may appropriately reduce the grayscales of all sub-pixel data of the image frame data D2, and then may compensate the image frame data after adjusting the grayscale so as to compensate for the sub-pixel degradation of the display module 10, thereby overcoming the technical issue of color shift. By reducing the grayscales of all sub-pixel data of the image frame data D2, the pixel degradation compensation circuit 220 may slow down the accumulation speed of the degradation value before the compensation region is saturated, thereby prolonging the saturation time of the compensation region to avoid the occurrence of color shift. In addition, by reducing the grayscales of all sub-pixel data of the image frame data, the pixel degradation compensation circuit 220 may reduce the additional compensation current for the sub-pixel circuit, thereby extending the lifetime of the sub-pixel circuit.

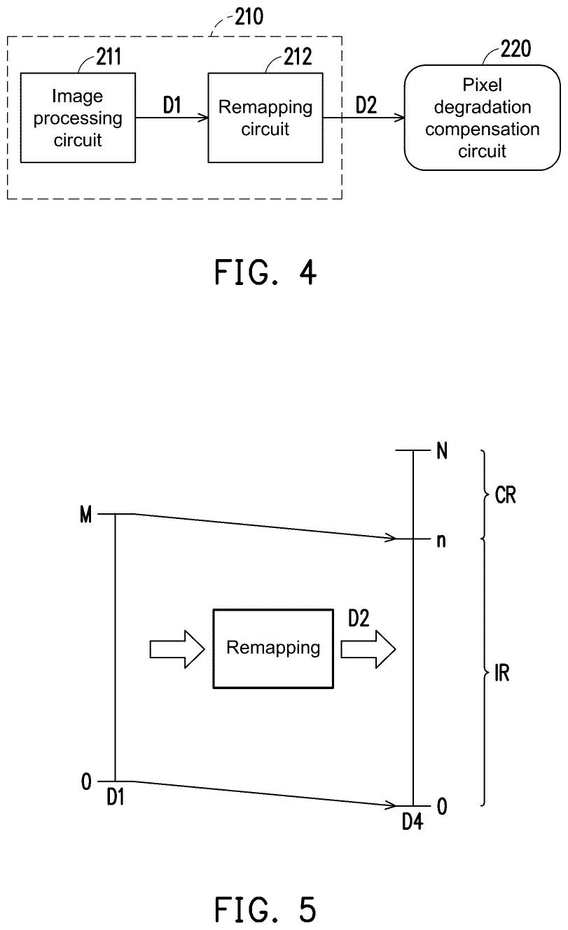

FIG. 4 is a schematic circuit block diagram of the processing circuit 210 according to an embodiment of the disclosure. The processing circuit 210 shown in FIG. 4 may be used as one of many implementation examples of the processing circuit 210 shown in FIG. 2. For the processing circuit 210 and the pixel degradation compensation circuit 220 shown in FIG. 4, reference may be made to the relevant description of FIG. 2, so the details are not repeated here. In the embodiment shown in FIG. 4, the processing circuit 210 includes an image processing circuit 211 and a remapping circuit 212. The output data of the image processing circuit 211 (an original image frame data D1) is input to the remapping circuit 212. The remapping circuit 212 is coupled to the image processing circuit 211 to receive the original image frame data D1. The remapping circuit 212 may remap the original image frame data D1 to the image frame data D2.

FIG. 5 is a schematic diagram of remapping the original image frame data D1 to the image frame data D2 according to an embodiment of the disclosure. The vertical axis of FIG. 5 represents grayscale. The left part of FIG. 5 shows the value range (total grayscale range) of the original image frame data D1. In the embodiment shown in FIG. 5, the value range of the original image frame data D1 is assumed to be 0 to M, where M is an integer determined according to the actual design. The right part of FIG. 5 shows the driving value range (total grayscale range) of the display module 10, that is, the value range of the compensated image frame data D4. The driving value range of the display module 10 may be divided into an image region IR and a compensation region CR. For example, assuming that the driving value range of the display module 10 is 0 to N, the grayscale range 0 to n may be defined as the image region IR, and the grayscale range n+1 to N may be defined as the compensation region CR, where n and N are integers determined according to the actual design, and 0<n<N. The remapping circuit 212 remaps the original image frame data D1 to the image frame data D2, where each sub-pixel data of the image frame data D2 belongs to the image region IR.

Referring to FIG. 2, the pixel degradation compensation circuit 220 generates the grayscale adjustment rate corresponding to the image frame data D2. For example, in some application examples, the operation of generating the grayscale adjustment rate corresponding to the image frame data D2 includes: counting the historical usage time of the display module 10; and correspondingly setting the grayscale adjustment rate based on the historical usage time. In other application examples, the operation of generating the grayscale adjustment rate corresponding to the image frame data D2 includes: converting each sub-pixel data of the image frame data D2 into the corresponding degradation value, where the corresponding degradation value represents a degradation effect of the corresponding sub-pixel data on a corresponding sub-pixel in the display module 10; finding the representative degradation value from a plurality of corresponding degradation values of all sub-pixel data of the image frame data D2; and correspondingly setting the grayscale adjustment rate based on the representative degradation value.

Based on the grayscale adjustment rate, the pixel degradation compensation circuit 220 may adjust the grayscales of all sub-pixel data of the image frame data D2 to generate the adjusted image frame data. Based on a certain sub-pixel data (the current sub-pixel data) in the adjusted image frame data, the pixel degradation compensation circuit 220 may generate the total degradation value corresponding to the current sub-pixel data. The pixel degradation compensation circuit 220 compensates the current sub-pixel data in the adjusted image frame data based on the total degradation value corresponding to the current sub-pixel data to generate the compensated current sub-pixel data in the compensated image frame data D4 to the display module 10.

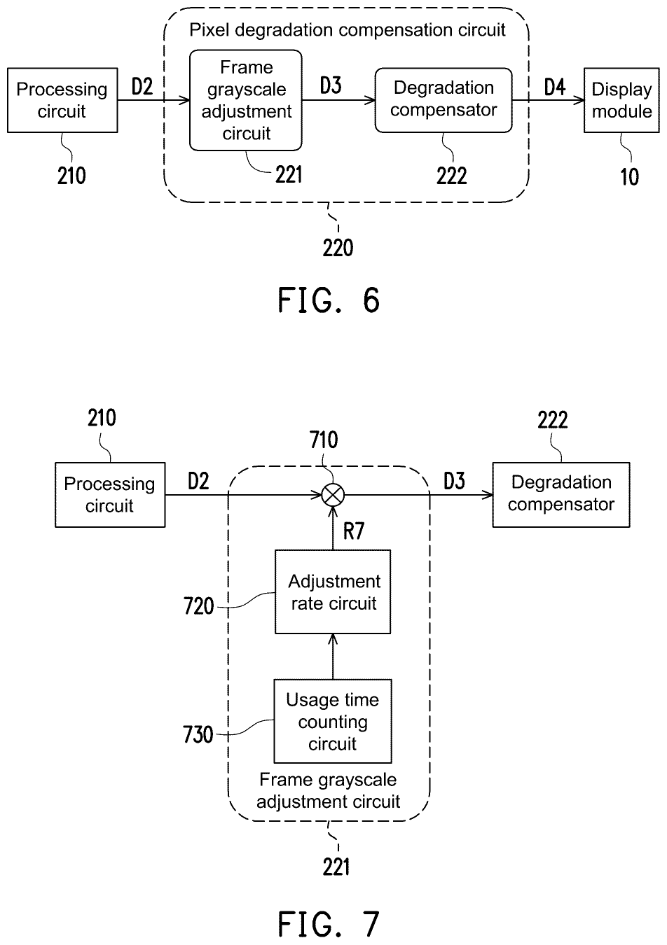

FIG. 6 is a schematic circuit block diagram of the pixel degradation compensation circuit 220 according to an embodiment of the disclosure. The pixel degradation compensation circuit 220 shown in FIG. 6 may be used as one of many implementation examples of the pixel degradation compensation circuit 220 shown in FIG. 2. For the processing circuit 210, the pixel degradation compensation circuit 220, and the display module 10 shown in FIG. 6, reference may be made to the relevant description of FIG. 2, so the details are not repeated here. In the embodiment shown in FIG. 6, the pixel degradation compensation circuit 220 includes a frame grayscale adjustment circuit 221 and a degradation compensator 222. The frame grayscale adjustment circuit 221 is coupled to the processing circuit 210 to receive the image frame data D2. The frame grayscale adjustment circuit 221 generates the grayscale adjustment rate corresponding to the image frame data D2. The frame grayscale adjustment circuit 221 adjusts the grayscales of all sub-pixel data of the image frame data D2 based on the grayscale adjustment rate to generate adjusted image frame data D3.

The degradation compensator 222 is coupled to the frame grayscale adjustment circuit 221 to receive the adjusted image frame data D3. The degradation compensator 222 generates the total degradation value corresponding to the current sub-pixel data in the adjusted image frame data D3 based on the current sub-pixel data. The degradation compensator 222 compensates the current sub-pixel data in the adjusted image frame data D3 based on the total degradation value corresponding to the current sub-pixel data to generate the compensated current sub-pixel data in the compensated image frame data D4 to the display module 10. The embodiment does not limit the degradation compensation algorithm of the degradation compensator 222. For example, the degradation compensator 222 may use a conventional degradation compensation algorithm or other degradation compensation algorithms to generate the compensated image frame data D4 to the display module 10.

FIG. 7 is a schematic circuit block diagram of the frame grayscale adjustment circuit 221 according to an embodiment of the disclosure. The frame grayscale adjustment circuit 221 shown in FIG. 7 may be used as one of many implementation examples of the frame grayscale adjustment circuit 221 shown in FIG. 6. For the processing circuit 210, the frame grayscale adjustment circuit 221, and the degradation compensator 222 shown in FIG. 7, reference may be made to the relevant description of FIG. 6, so the details are not repeated here. In the embodiment shown in FIG. 7, the frame grayscale adjustment circuit 221 includes a multiplier 710, an adjustment rate circuit 720, and a usage time counting circuit 730. The usage time counting circuit 730 counts the historical usage time of the display module 10. The adjustment rate circuit 720 is coupled to the usage time counting circuit 730. The adjustment rate circuit 720 sets a grayscale adjustment rate R7 accordingly based on the historical usage time provided by the usage time counting circuit 730.

For example (but not limited thereto), in response to the historical usage time of the display module 10 falling within the initial usage time zone (such as 0 to 100 hours, but not limited thereto), the adjustment rate circuit 720 sets the grayscale adjustment rate R7 to the initial adjustment rate (such as 1, but not limited thereto). In response to the historical usage time of the display module 10 falling within a usage time zone after the initial usage time zone (the first usage time zone, such as 5000 to 10000 hours, but not limited thereto), the adjustment rate circuit 720 sets the grayscale adjustment rate R7 to a certain adjustment rate that is less than the initial adjustment rate (the first adjustment rate, such as 0.9, but not limited thereto). In response to the historical usage time of the display module 10 falling within another usage time zone after the first usage time zone (the second usage time zone, such as 10,000 to 15,000 hours, but not limited thereto), the adjustment rate circuit 720 sets the grayscale adjustment rate R7 to another adjustment rate that is less than the first adjustment rate (the second adjustment rate, such as 0.8, but not limited thereto).

The adjustment rate circuit 720 may use a lookup table mechanism or other mechanisms to convert the historical usage time provided by the usage time counting circuit 730 into the grayscale adjustment rate R7. The multiplier 710 is coupled to the adjustment rate circuit 720 to receive the grayscale adjustment rate R7. The multiplier 710 is also coupled to the processing circuit 210 to receive the image frame data D2. The multiplier 710 multiplies all sub-pixel data of the image frame data D2 by the grayscale adjustment rate R7 to generate the adjusted image frame data D3 to the degradation compensator 222.

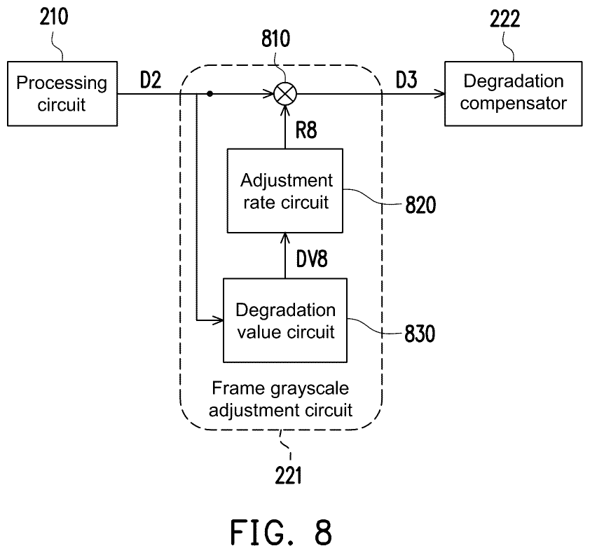

FIG. 8 is a schematic circuit block diagram of the frame grayscale adjustment circuit 221 according to another embodiment of the disclosure. The frame grayscale adjustment circuit 221 shown in FIG. 8 may be used as one of many implementation examples of the frame grayscale adjustment circuit 221 shown in FIG. 6. For the processing circuit 210, the frame grayscale adjustment circuit 221, and the degradation compensator 222 shown in FIG. 8, reference may be made to the relevant description of FIG. 6, so the details are not repeated here. In the embodiment shown in FIG. 8, the frame grayscale adjustment circuit 221 includes a multiplier 810, an adjustment rate circuit 820, and a degradation value circuit 830.

The degradation value circuit 830 is coupled to the processing circuit 210 to receive the image frame data. The degradation value circuit 830 converts each sub-pixel data of the image frame data D2 into a corresponding degradation value. The corresponding degradation value represents the degradation effect of the corresponding sub-pixel data (drive current) on a corresponding sub-pixel in the display module 10. The embodiment does not limit the algorithm of the degradation value. For example, the degradation value circuit 830 may use a conventional algorithm or other algorithms to calculate the degradation value corresponding to each sub-pixel data of the image frame data D2 based on at least one of many decay factors such as sub-pixel data (drive current), usage time, temperature, etc. The degradation value circuit 830 finds a representative degradation value DV8 from the plurality of corresponding degradation values of all sub-pixel data of the image frame data D2, and then provides the representative degradation value DV8 to the adjustment rate circuit 820. For example (but not limited thereto), the representative degradation value DV8 is a maximum degradation value among the plurality of corresponding degradation values of all sub-pixel data of the image frame data D2.

The adjustment rate circuit 820 is coupled to the degradation value circuit 830 to receive the representative degradation value DV8. The adjustment rate circuit 820 sets a grayscale adjustment rate R8 correspondingly based on the representative degradation value DV8. For example (but not limited thereto), in response to the representative degradation value DV8 indicating no degradation, the adjustment rate circuit 820 sets the grayscale adjustment rate R8 to the initial adjustment rate (such as 1, but not limited thereto). In response to the representative degradation value DV8 indicating degradation, the adjustment rate circuit 820 sets the grayscale adjustment rate R8 to a certain corresponding adjustment rate that is less than the initial adjustment rate, where the corresponding adjustment rate corresponds to the representative degradation value DV8. For example, in response to the representative degradation value DV8 falling within a certain degradation value region (such as the first degradation value region), the adjustment rate circuit 820 sets the grayscale adjustment rate R8 to the first adjustment rate (such as 0.9, but not limited thereto). In response to the representative degradation value DV8 falling within another degradation value region (the second degradation value region) after the first degradation value region, the adjustment rate circuit 820 sets the grayscale adjustment rate R8 to another adjustment rate (the second adjustment rate, such as 0.8, but not limited thereto) that is less than the first adjustment rate.

The adjustment rate circuit 820 may use a lookup table mechanism or other mechanisms to convert the representative degradation value DV8 provided by the degradation value circuit 830 into the grayscale adjustment rate R8. The multiplier 810 is coupled to the adjustment rate circuit 820 to receive the grayscale adjustment rate R8. The multiplier 810 is also coupled to the processing circuit 210 to receive the image frame data D2. The multiplier 810 multiplies all sub-pixel data of the image frame data D2 by the grayscale adjustment rate R8 to generate the adjusted image frame data D3.

Referring to FIG. 6, the degradation compensator 222 generates the total degradation value corresponding to the current sub-pixel data. The operation of generating the total degradation value corresponding to the current sub-pixel data includes: generating a current degradation value corresponding to the current sub-pixel data in the adjusted image frame data D3 based on the current sub-pixel data; and accumulating the current degradation value to the total degradation value corresponding to the current sub-pixel data. The current degradation value represents a current degradation effect of the current sub-pixel data on a certain sub-pixel corresponding to the current sub-pixel data in the display module 10. Based on the total degradation value corresponding to the current sub-pixel data, the degradation compensator 222 generates the compensated current sub-pixel data in the compensated image frame data D4 to the display module 10. The operation of generating the compensated current sub-pixel data in the compensated image frame data includes: generating a compensation value based on the total degradation value corresponding to the current sub-pixel data; and compensating the current sub-pixel data in the adjusted image frame data D3 based on the compensation value to generate the compensated current sub-pixel data to the display module 10.

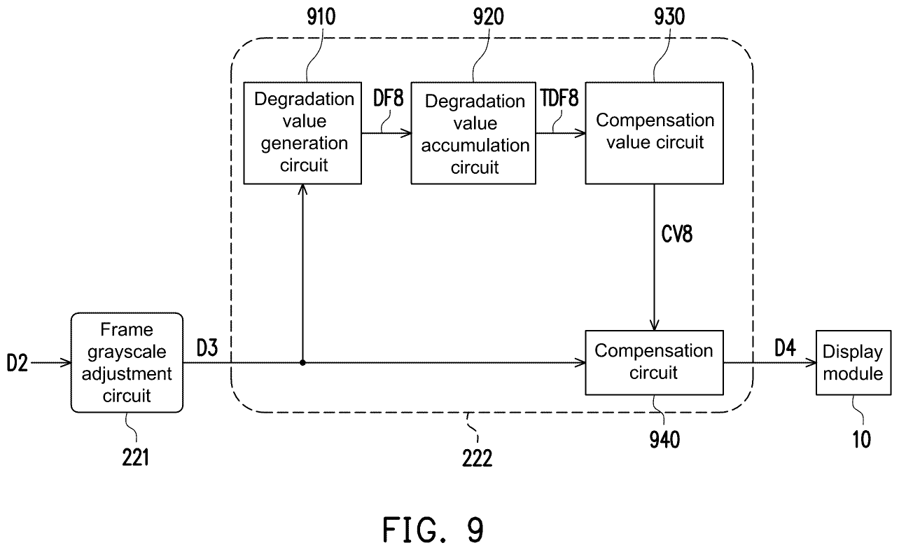

FIG. 9 is a schematic circuit block diagram of the degradation compensator 222 according to an embodiment of the disclosure. The degradation compensator 222 shown in FIG. 9 may be used as one of many implementation examples of the degradation compensator 222 shown in FIG. 6. For the frame grayscale adjustment circuit 221, the degradation compensator 222, and the display module 10 shown in FIG. 9, reference may be made to the relevant description of FIG. 6, so the details are not repeated here. In the embodiment shown in FIG. 9, the degradation compensator 222 includes a degradation value generation circuit 910, a degradation value accumulation circuit 920, a compensation value circuit 930, and a compensation circuit 940. The degradation value generation circuit 910 is coupled to the frame grayscale adjustment circuit 221 to receive the adjusted image frame data D3. The degradation value generation circuit 910 generates the current degradation value corresponding to the current sub-pixel data in the adjusted image frame data D3 based on the current sub-pixel data. The current degradation value represents the degradation effect of the current sub-pixel data (drive current) on a certain sub-pixel corresponding to the current sub-pixel data in the display module 10. The embodiment does not limit the algorithm of the degradation value. For example, the degradation value generation circuit 910 may use a conventional algorithm or other algorithms to calculate a current degradation value DF8 corresponding to the current sub-pixel data based on at least one of many decay factors such as sub-pixel data (drive current), usage time, temperature, etc.

The degradation value accumulation circuit 920 is coupled to the degradation value generation circuit 910 to receive the current degradation value DF8. The degradation value accumulation circuit 920 accumulates the current degradation value DF8 corresponding to the current sub-pixel data to a total degradation value TDF8 corresponding to the current sub-pixel data. The degradation value accumulation circuit 920 may save the total degradation value TDF8 corresponding to each sub-pixel of the display module 10. For example, assuming that the display module 10 has x*y pixels and each pixel has three sub-pixels of different colors, the degradation value accumulation circuit 920 may save x*y*3 total degradation values in the total degradation value lookup table. Each total degradation value represents the current degradation degree of a certain corresponding sub-pixel.

The compensation value circuit 930 is coupled to the degradation value accumulation circuit 920 to receive the total degradation value TDF8. The compensation value circuit 930 generates a compensation value CV8 corresponding to the current sub-pixel data based on the total degradation value TDF8. In some application examples, the compensation value circuit 930 may use a lookup table mechanism, a calculation mechanism, or other mechanisms to convert the total degradation value TDF8 into the compensation value CV8. For example, the compensation value circuit 930 may use a conventional algorithm or other algorithms to convert the total degradation value TDF8 into the compensation value CV8. For another example, the compensation value circuit 930 may obtain the compensation value CV8 from the lookup table based on the total degradation value TDF8.

The compensation circuit 940 is coupled to the compensation value circuit 930 to receive the compensation value CV8. The compensation circuit 940 is also coupled to the frame grayscale adjustment circuit 221 to receive the adjusted image frame data D3. The compensation circuit 940 compensates the current sub-pixel data in the adjusted image frame data D3 based on the compensation value CV8 to generate the compensated current sub-pixel data in the compensated image frame data D4 to the display module 10. For example, the compensation circuit 940 may add the compensation value CV8 to the current sub-pixel data in the adjusted image frame data D3 to generate the compensated current sub-pixel data in the compensated image frame data D4 to the display module 10.

Although the disclosure has been described with reference to the embodiments above, the embodiments are not intended to limit the disclosure. Any person skilled in the art may make some changes and modifications without departing from the spirit and scope of the disclosure. Therefore, the scope of the disclosure will be defined in the appended claims.

1. A processor comprising:
a processing circuit; and
a pixel degradation compensation circuit, coupled to the processing circuit to receive image frame data, and configured to compensate the image frame data to generate compensated image frame data to a display module, wherein the pixel degradation compensation circuit generates a grayscale adjustment rate corresponding to the image frame data, the pixel degradation compensation circuit adjusts grayscales of all sub-pixel data of the image frame data based on the grayscale adjustment rate to generate adjusted image frame data, the pixel degradation compensation circuit generates a total degradation value corresponding to current sub-pixel data in the adjusted image frame data based on the current sub-pixel data, the total degradation value represents a historical degradation effect of the current sub-pixel data on a sub-pixel corresponding to the current sub-pixel data in the display module, and the pixel degradation compensation circuit compensates the current sub-pixel data in the adjusted image frame data based on the total degradation value corresponding to the current sub-pixel data to generate compensated current sub-pixel data in the compensated image frame data to the display module,
wherein an operation of generating the grayscale adjustment rate corresponding to the image frame data comprises:
converting each sub-pixel data of the image frame data into a corresponding degradation value, where the corresponding degradation value represents a degradation effect of corresponding sub-pixel data on a corresponding sub-pixel in the display module;
finding a representative degradation value from a plurality of corresponding degradation values of all sub-pixel data of the image frame data; and
setting the grayscale adjustment rate correspondingly based on the representative degradation value.

2. The processor according to claim 1, wherein a driving value range of the display module is divided into an image region and a compensation region, each sub-pixel data of the image frame data belongs to the image region, and the processing circuit remaps an original image frame data to the image frame data.

3. The processor according to claim 1, wherein an operation of generating the grayscale adjustment rate corresponding to the image frame data comprises:
counting a historical usage time of the display module; and
setting the grayscale adjustment rate correspondingly based on the historical usage time.

4. The processor according to claim 3, wherein,
in response to the historical usage time falling within an initial usage time zone, the grayscale adjustment rate is set to an initial adjustment rate;
in response to the historical usage time falling within a first usage time zone after the initial usage time zone, the grayscale adjustment rate is set to a first adjustment rate that is less than the initial adjustment rate; and
in response to the historical usage time falling within a second usage time zone after the first usage time zone, the grayscale adjustment rate is set to a second adjustment rate that is less than the first adjustment rate.

5. The processor according to claim 4, wherein the initial adjustment rate is 1.

6. (canceled)

7. The processor according to claim 1, wherein the representative degradation value is a maximum degradation value among the plurality of corresponding degradation values of all sub-pixel data of the image frame data.

8. The processor according to claim 1, wherein the operation of generating the grayscale adjustment rate corresponding to the image frame data further comprises:
in response to the representative degradation value indicating no degradation, setting the grayscale adjustment rate to 1; and
in response to the representative degradation value indicating degradation, setting the grayscale adjustment rate to a corresponding adjustment rate less than 1, wherein the corresponding adjustment rate corresponds to the representative degradation value.

9. The processor according to claim 1, wherein an operation of generating the adjusted image frame data comprises:
multiplying each sub-pixel data of the image frame data by the grayscale adjustment rate to generate the adjusted image frame data.

10. The processor according to claim 1, wherein an operation of generating the total degradation value corresponding to the current sub-pixel data comprises:
generating a current degradation value corresponding to the current sub-pixel data in the adjusted image frame data based on the current sub-pixel data, wherein the current degradation value represents a current degradation effect of the current sub-pixel data on a sub-pixel corresponding to the current sub-pixel data in the display module; and
accumulating the current degradation value to the total degradation value corresponding to the current sub-pixel data.

11. The processor according to claim 1, wherein an operation of generating the compensated current sub-pixel data in the compensated image frame data comprises:
generating a compensation value based on the total degradation value corresponding to the current sub-pixel data; and
compensating the current sub-pixel data in the adjusted image frame data based on the compensation value to generate the compensated current sub-pixel data to the display module.

12. The processor according to claim 1, wherein the processing circuit comprises:
an image processing circuit; and
a remapping circuit coupled to the image processing circuit to receive an original image frame data, wherein a driving value range of the display module is divided into an image region and a compensation region, each sub-pixel data of the image frame data belongs to the image region, and the remapping circuit remaps the original image frame data to the image frame data.

13. The processor according to claim 1, wherein the pixel degradation compensation circuit comprises:
a frame grayscale adjustment circuit coupled to the processing circuit to receive the image frame data, wherein the frame grayscale adjustment circuit generates the grayscale adjustment rate corresponding to the image frame data, and the frame grayscale adjustment circuit adjusts the grayscales of all sub-pixel data of the image frame data based on the grayscale adjustment rate to generate the adjusted image frame data; and
a degradation compensator coupled to the frame grayscale adjustment circuit to receive the adjusted image frame data, wherein the degradation compensator generates the total degradation value corresponding to the current sub-pixel data in the adjusted image frame data based on the current sub-pixel data, and the degradation compensator compensates the current sub-pixel data in the adjusted image frame data based on the total degradation value corresponding to the current sub-pixel data to generate the compensated current sub-pixel data in the compensated image frame data to the display module.

14. The processor according to claim 13, wherein the frame grayscale adjustment circuit comprises:
a usage time counting circuit configured to count a historical usage time of the display module;
an adjustment rate circuit coupled to the usage time counting circuit, wherein the adjustment rate circuit correspondingly sets the grayscale adjustment rate based on the historical usage time; and
a multiplier coupled to the adjustment rate circuit to receive the grayscale adjustment rate, and coupled to the processing circuit to receive the image frame data, wherein the multiplier multiplies all sub-pixel data of the image frame data by the grayscale adjustment rate to generate the adjusted image frame data.

15. The processor according to claim 13, wherein the frame grayscale adjustment circuit comprises:
a degradation value circuit coupled to the processing circuit to receive the image frame data, wherein the degradation value circuit converts each sub-pixel data of the image frame data into the corresponding degradation value, the corresponding degradation value represents a degradation effect of corresponding sub-pixel data on a corresponding sub-pixel in the display module, and the degradation value circuit finds a representative degradation value from the plurality of corresponding degradation values of all sub-pixel data of the image frame data;
an adjustment rate circuit coupled to the degradation value circuit to receive the representative degradation value, wherein the adjustment rate circuit correspondingly sets the grayscale adjustment rate based on the representative degradation value; and
a multiplier coupled to the adjustment rate circuit to receive the grayscale adjustment rate, and coupled to the processing circuit to receive the image frame data, wherein the multiplier multiplies all sub-pixel data of the image frame data by the grayscale adjustment rate to generate the adjusted image frame data.

16. The processor according to claim 13, wherein the degradation compensator comprises:
a degradation value generation circuit coupled to the frame grayscale adjustment circuit to receive the adjusted image frame data, wherein the degradation value generation circuit generates a current degradation value corresponding to the current sub-pixel data in the adjusted image frame data based on the current sub-pixel data;
a degradation value accumulation circuit coupled to the degradation value generation circuit to receive the current degradation value, wherein the degradation value accumulation circuit accumulates the current degradation value corresponding to the current sub-pixel data to the total degradation value corresponding to the current sub-pixel data;
a compensation value circuit coupled to the degradation value accumulation circuit to receive the total degradation value, wherein the compensation value circuit generates a compensation value corresponding to the current sub-pixel data based on the total degradation value; and
a compensation circuit coupled to the frame grayscale adjustment circuit to receive the adjusted image frame data, and coupled to the compensation value circuit to receive the compensation value, wherein the compensation circuit compensates the current sub-pixel data in the adjusted image frame data based on the compensation value to generate the compensated current sub-pixel data to the display module.

17. A pixel degradation compensation method comprising:
generating a grayscale adjustment rate corresponding to image frame data;
based on the grayscale adjustment rate, adjusting grayscales of all sub-pixel data of the image frame data to generate adjusted image frame data;
based on a current sub-pixel data in the adjusted image frame data, generating a total degradation value corresponding to the current sub-pixel data, wherein the total degradation value represents a historical degradation effect of the current sub-pixel data on a sub-pixel corresponding to the current sub-pixel data in a display module; and
based on the total degradation value corresponding to the current sub-pixel data, compensating the current sub-pixel data in the adjusted image frame data to generate compensated current sub-pixel data in compensated image frame data to the display module,
wherein an operation of generating the grayscale adjustment rate corresponding to the image frame data comprises:
converting each sub-pixel data of the image frame data into a corresponding degradation value, wherein the corresponding degradation value represents a degradation effect of corresponding sub-pixel data on a corresponding sub-pixel in the display module;
finding a representative degradation value from a plurality of corresponding degradation values of all sub-pixel data of the image frame data; and
setting the grayscale adjustment rate correspondingly based on the representative degradation value.

18. The pixel degradation compensation method according to claim 17, wherein a driving value range of the display module is divided into an image region and a compensation region, each sub-pixel data of the image frame data belongs to the image region, and the pixel degradation compensation method further comprises:
remapping an original image frame data to the image frame data.

19. The pixel degradation compensation method according to claim 17, wherein an operation of generating the grayscale adjustment rate corresponding to the image frame data comprises:
counting a historical usage time of the display module; and
setting the grayscale adjustment rate correspondingly based on the historical usage time.

20. The pixel degradation compensation method according to claim 19, wherein an operation of setting the grayscale adjustment rate comprises:
in response to the historical usage time falling within an initial usage time zone, setting the grayscale adjustment rate to an initial adjustment rate;
in response to the historical usage time falling within a first usage time zone after the initial usage time zone, setting the grayscale adjustment rate to a first adjustment rate that is less than the initial adjustment rate; and
in response to the historical usage time falling within a second usage time zone after the first usage time zone, setting the grayscale adjustment rate to a second adjustment rate that is less than the first adjustment rate.

21. The pixel degradation compensation method according to claim 20, wherein the initial adjustment rate is 1.

22. (canceled)

23. The pixel degradation compensation method according to claim 17, wherein the representative degradation value is a maximum degradation value among the plurality of corresponding degradation values of all sub-pixel data of the image frame data.

24. The pixel degradation compensation method according to claim 17, wherein the operation of generating the grayscale adjustment rate corresponding to the image frame data further comprises:
in response to the representative degradation value indicating no degradation, setting the grayscale adjustment rate to 1; and
in response to the representative degradation value indicating degradation, setting the grayscale adjustment rate to a corresponding adjustment rate less than 1, wherein the corresponding adjustment rate corresponds to the representative degradation value.

25. The pixel degradation compensation method according to claim 17, wherein an operation of generating the adjusted image frame data comprises:
multiplying each sub-pixel data of the image frame data by the grayscale adjustment rate to generate the adjusted image frame data.

26. The pixel degradation compensation method according to claim 17, wherein an operation of generating the total degradation value corresponding to the current sub-pixel data comprises:
generating a current degradation value corresponding to the current sub-pixel data in the adjusted image frame data based on the current sub-pixel data, wherein the current degradation value represents a current degradation effect of the current sub-pixel data on a sub-pixel corresponding to the current sub-pixel data in the display module; and
accumulating the current degradation value to the total degradation value corresponding to the current sub-pixel data.

27. The pixel degradation compensation method according to claim 17, wherein an operation of generating the compensated current sub-pixel data in the compensated image frame data comprises:
generating a compensation value based on the total degradation value corresponding to the current sub-pixel data; and
compensating the current sub-pixel data in the adjusted image frame data based on the compensation value to generate the compensated current sub-pixel data to the display module.
